(19) United States
(12) Patent Application Publication
(10) Pub. No.: US 2009/0002990 A1
(43) Pub. Date: Jan. 1, 2009

(54) LED LIGHTING ASSEMBLIES FOR DISPLAY CASES

(76) Inventors: Aaron James Becker, Covington, GA (US); Shane Elizabeth Bode, Smyrna, GA (US); Denise Bonsell, Grayson, GA (US); Mark Anthony Hand, Covington, GA (US); Michael Ray Miller, Conyers, GA (US); Jeffrey Mansfield Quinlan, Covington, GA (US); Gregory Brian Simons, Loganville, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 12/164,822

(22) Filed: Jun. 30, 2008

Related U.S. Application Data
(60) Provisional application No. 60/937,678, filed on Jun. 29, 2007.
(60) Provisional application No. 60/997,999, filed on Oct. 5, 2007.

(51) Int. Cl. F21V 21/00; B23P 19/00

(52) U.S. Cl. 362/249; 29/762

(57) ABSTRACT

Embodiments of lighting assemblies disclosed herein are particularly designed for installation in display units to more effectively distribute light towards, and thereby better illuminate, the products housed in the display unit. The lighting assemblies include at least one, but preferably a plurality of, light emitting diodes mounted on a frame. The frame is preferably formed so as to have a number of mounting arms on which to mount the LEDs. In this way, the LEDs can be positioned on the arms and their emitted light can be directed to focus on different aspects of the display unit (i.e., the products housed in the unit, banners or advertisements on the unit, etc.). The lighting assemblies may include, but do not have to include, various optical features to enhance the distribution of light emitted from the LEDs, including, but not limited to, lenses, reflectors, etc. The lighting assemblies disclosed herein may be retrofit into existing refrigerated display units illuminated by fluorescent bulbs or installed in new units during assembly.

### CROSS-REFERENCE TO RELATED APPLICATIONS

This application claims the benefit of U.S. Provisional Application No. 60/937,678, entitled “Refrigeration Lighting Unit” and filed Jun. 29, 2007, and the benefit of U.S. Provisional Application No. 60/997,999, entitled “Refrigeration Lighting Unit” and filed Oct. 5, 2007, the entirety of each of which is herein incorporated by reference.

### FIELD OF THE INVENTION

Embodiments of the invention relate to LED lighting assemblies that can be quickly and easily installed in display cases and particularly refrigerated display units.

### BACKGROUND OF THE INVENTION

Display cases, including refrigeration units that house a variety of products, including beverages, frozen foods, etc., historically have used fluorescent sources to light the interior of the case. However, the fluorescent bulbs used in such applications have limited life and must be replaced often. The electrodes in fluorescent bulbs are easily burnt out or broken, requiring that the entire bulb be replaced. Moreover, the glass bulbs themselves are susceptible to breakage.

The fluorescent bulbs have been positioned in various locations within the cases, including at the top or along the sides of the unit. A lamp provided at the top of the unit illuminates the products positioned near the top of the case, but fails to adequately illuminate those products positioned lower within the case. This is particularly true if all of the shelves have the same depth. The use of multiple lamps positioned vertically down the sides of the case illuminate the products located towards the sides of the case but inadequately illuminate those positioned more central within the case. Moreover, the use of multiple lamps increases the energy and thus cost needed to adequately illuminate the case. There is a need to illuminate products with a display case more efficiently and effectively.

### SUMMARY OF EMBODIMENTS OF THE INVENTION

Embodiments of lighting assemblies disclosed herein are particularly designed for installation in display units to more effectively distribute light towards, and thereby better illuminate, the products housed in the display unit. The lighting assemblies include at least one, but preferably a plurality of, light emitting diodes mounted on a frame.

Any frame geometry and configuration and any number of LEDs positioned in any number of locations on the frame may be used. The frame is preferably formed so as to have a number of mounting arms on which to mount the LEDs. In this way, the LEDs can be positioned on the arms and their emitted light can be directed to focus on different aspects of the display unit (i.e., the products housed in the unit, banners or advertisements on the unit, etc.). The lighting assemblies may include, but do not have to include, various optical features to enhance the distribution of light emitted from the LEDs, including, but not limited to, lenses, reflectors, etc.

The lighting assemblies disclosed herein may be retrofit into existing refrigerated display units illuminated by fluorescent bulbs or installed in new units during assembly. Regardless of whether the lighting assemblies are installed in existing or new display units, they are easily removable from and replaceable in such units.

While not required, provision of staggered shelving within the display unit is preferable. In its simplest arrangement, all shelves are staggered such that the depth of the shelves gradually increases from top to bottom. Such an arrangement allows the light emanating from the top of the refrigerated display unit to better reach and illuminate the products located on the lower shelves.

### BRIEF DESCRIPTION OF THE DRAWINGS

FIG. 1 is a front perspective view of a refrigerated display unit lit with a fluorescent bulb and into which embodiments of the lighting assemblies of this invention may be installed.

FIG. 2 is a front perspective view of a lighting assembly according to one embodiment of the present invention, where a portion of each lens has been removed to reveal the light emitting diodes positioned beneath the lenses.

FIG. 3 is a cross-sectional view of the lighting assembly of FIG. 2 taken along line 3-3.

FIG. 4 is a cross-sectional view of a lighting assembly according to another embodiment of the present invention.

FIG. 5 is a cross-sectional view of a lighting assembly according to yet another embodiment of the present invention.

FIG. 6 is an exploded view of the lighting assembly of FIG. 2 being installed within the refrigerated display unit of FIG. 1.

FIG. 7 is a front perspective view of the lighting assembly of FIG. 2 installed within the refrigerated display unit of FIG. 1.

FIG. 8 is a rear perspective view of the refrigerated display unit of FIG. 7.

FIG. 9 is a cross-sectional view of the refrigerated display unit of FIG. 7 taken along line 9-9.

### DETAILED DESCRIPTION OF EMBODIMENTS OF THE INVENTION

Embodiments of this invention provide lighting assemblies for installation in refrigerated display units. While the lighting assemblies are discussed for use with refrigerated display units, they by no means are so limited. Rather, embodiments of the lighting assemblies may be used in display cases of any type.

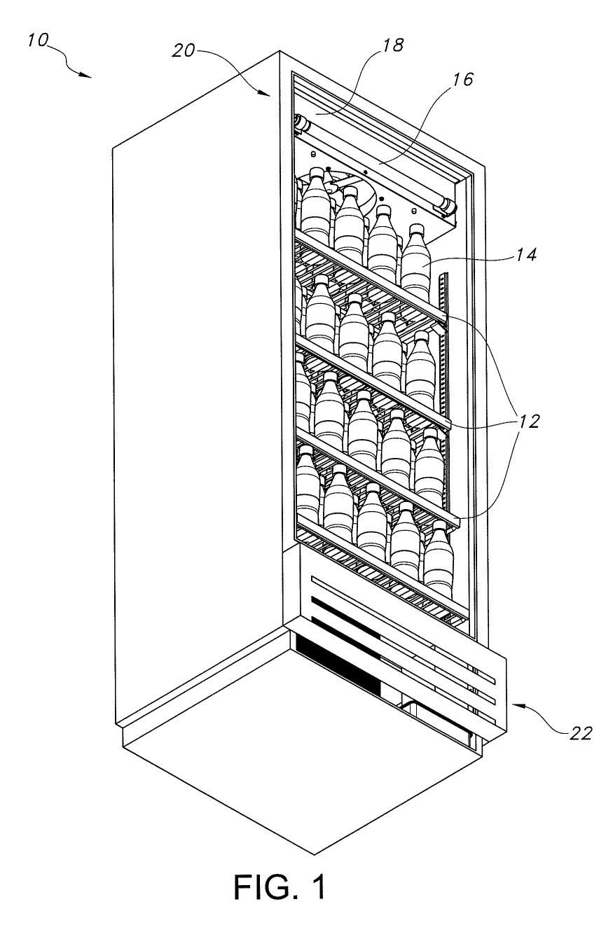

FIG. 1 illustrates one embodiment of a refrigerated display unit 10 into which lighting assemblies of this invention may be installed. The refrigerated display unit 10 includes shelves 12 for supporting beverages 14. A fluorescent bulb 16 mounted on a mounting panel 18 is positioned in the top 20 of the unit 10, and a fluorescent ballast (not shown) is housed in a lower compartment 22 of the refrigerated display unit 10. This is but one of many possible configurations of the fluorescent bulb 16 within the unit 10. A banner (not shown) can be located on the front door (which has been removed in FIG. 1 for illustrative purposes) of the refrigeration unit 10, typically for advertising the products housed within the unit 10.

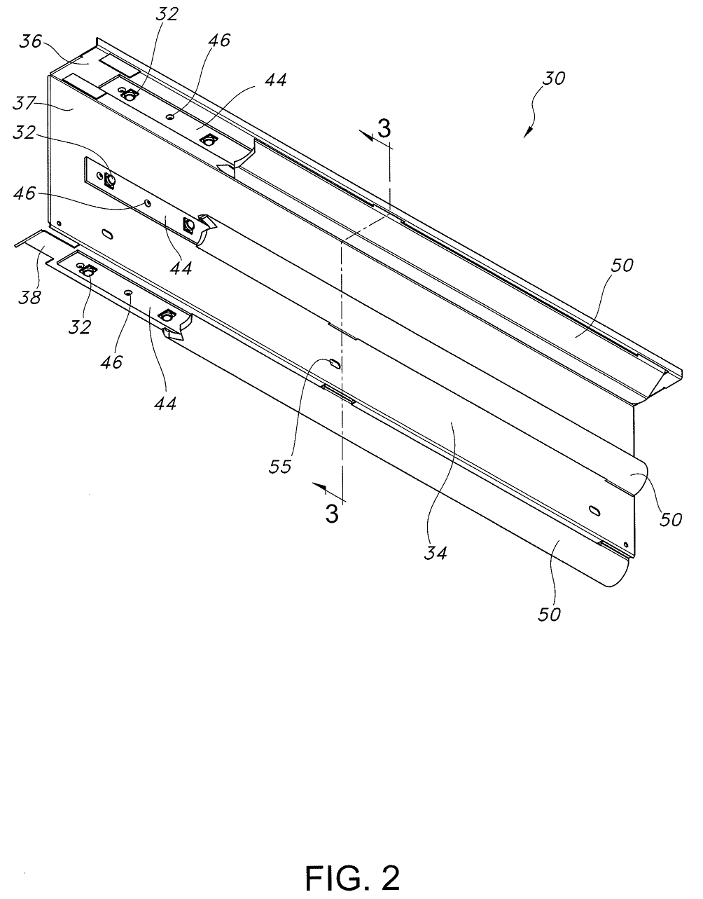

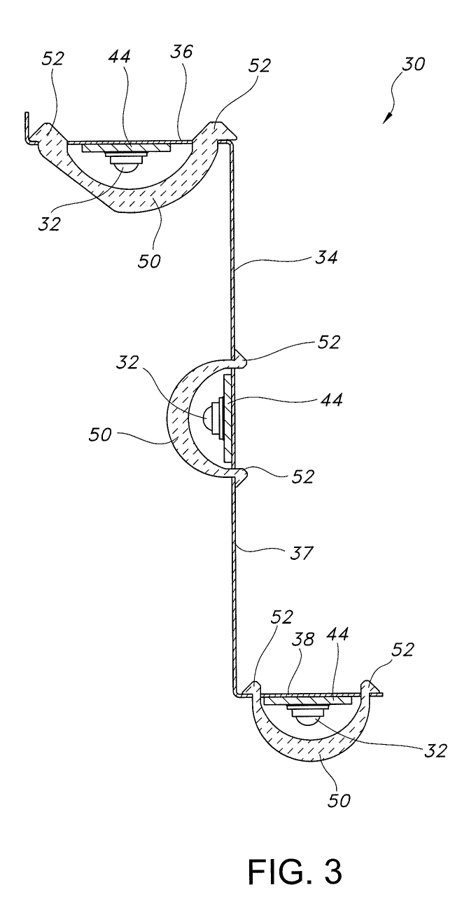

FIGS. 2-5 illustrate embodiments of lighting assemblies for installation in display units such as the refrigerated display unit 10 illustrated in FIG. 1. More specifically, embodiments of the light assemblies disclosed herein are particularly designed for installation in the top 20 of the refrigerated display unit 10 such that light more effectively distributes light towards, and thereby better illuminates, the products housed in the refrigerated display unit 10.

Embodiments of the lighting assemblies 30 include at least one, but preferably a plurality of, light emitting diodes 32 mounted on a frame 34. For ease of discussion, the light sources are referred to generally as LEDs 32. However, the LEDs referenced herein can be single-die or multi-die light emitting diodes, DC or AC, or can be an organic light emitting diodes (O-LEDs). The LEDs may be oriented in a straight or staggered arrangement on frame 34.

The frame 34 may be formed from any metallic material (such as, but not limited to, aluminum or steel) or polymeric material (such as, but not limited to, thermoplastic or thermoset materials). Whatever the material used, it is preferable, but not required, that the frame 34 be formed from a reflective material or treated so as to render the frame 34 reflective, such as by painting a reflective coating on its exterior surface.

In one embodiment, the frame 34 is metal and is formed by stamping a metal blank and then forming the blank into a desired frame shape. In this way, the frames 34 may be sized to fit within the refrigerated display unit 10 and formed so as to provide the desired number of surfaces on which to mount the LEDs 32. Other manufacturing methods, including, but not limited to, injection-molding, stamping, compression-molding, etc., may also be employed to make the frame 34.

The frame 34 can be formed into various shapes depending on the desired illumination within the refrigerated display unit 10. While the frame 34 may simply be a planar surface on which the LEDs 32 are mounted, it is preferably formed so as to have a number of mounting arms (e.g., 36-38) on which to mount the LEDs 32. For example, FIGS. 2-4 illustrate frames 34 having three mounting arms 36, 37, 38 on which to mount the LEDs 32. The LEDs 32 on the top arm 36 and the bottom arm 38 can direct light primarily downwardly onto the products housed in the refrigerated display unit 10, and the LEDs 32 positioned on the middle arm 37 can direct light primarily outwardly to illuminate a banner or other advertisement (not shown) on the refrigerated display unit 10.

The frames 34 can have fewer or more than three mounting arms however. Moreover, LEDs 32 need not be provided on every arm but rather can be selectively provided to effect the desired illumination. By way only of example, LEDs need not be provided on the middle arm 37 but rather the light emitted from the LEDs 32 provided on the top arm 36 can be directed outwardly or downwardly and outwardly to illuminate a banner and the light emitted from the LEDs 32 on the bottom arm 38 can be directed downwardly or downwardly and inwardly to illuminate the products. Alternatively, LEDs 32 may be provided only on the middle and bottom mounting arms 37, 38 and not on the top mounting arm 36.

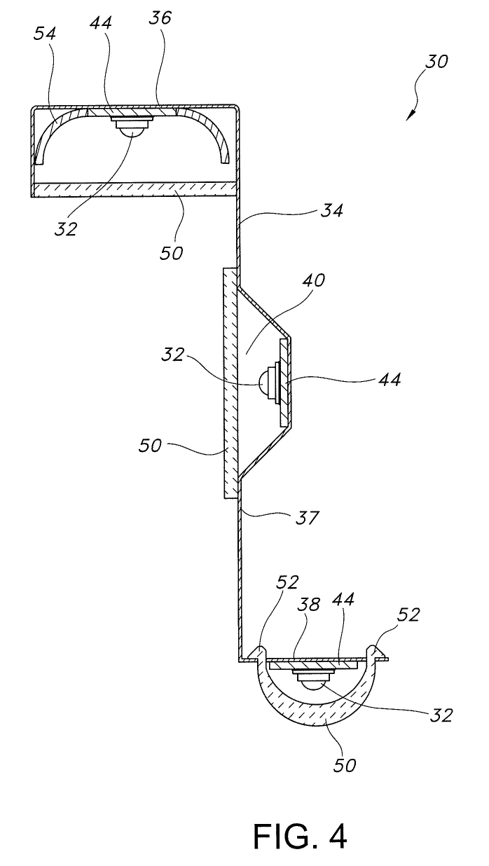

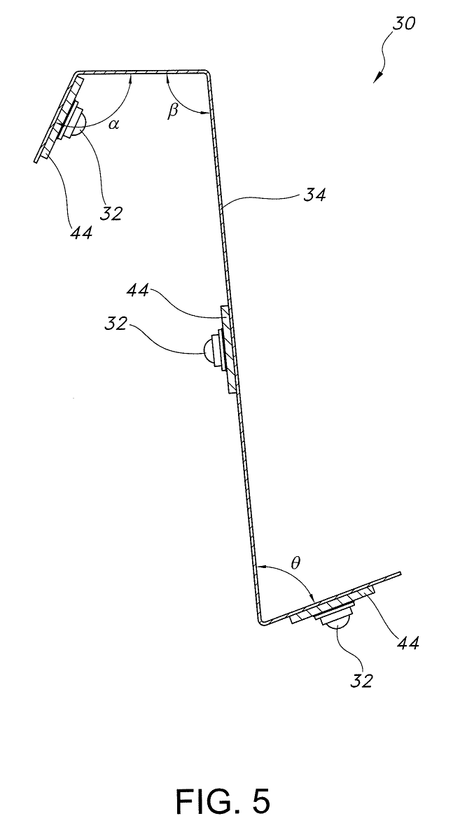

Any number of mounting arms may be provided. The mounting arms can be planar or can be contoured. By way only of example, FIG. 4 illustrates a frame 34 whereby the middle arm 37 includes a recess 40 in which the LEDs 32 are positioned. Moreover, the mounting arms need not be oriented perpendicular to each other, but rather can be oriented at various angles (see e.g., angles β, θ, α in FIG. 5) to direct the light emitted from the LEDs 32 as desired. Again, any frame 34 geometry and configuration and number of LEDs 32 positioned in any number of locations on the frame 34 may be used.

While the LEDs 32 may be mounted directly to the frame 34, they are preferably first mounted on a printed circuit board 44 (e.g., metal core board, FR4 board, CHM1 board, etc.) that is subsequently attached to the frame 32 via any mechanical or chemical retention method, including the use of mechanical fasteners or adhesive. In one embodiment, screws 46 are used to secure the printed circuit boards 44 to the frame 34. While dissipation of the heat generated by the LEDs 32 is not of particular concern in refrigeration applications, if the display unit is not refrigerated, provision of heat sinks and/or thermal pads in association with the printed circuit board may be desirable to direct heat away from the LEDs and thereby prevent their overheating.

The lighting assemblies 30 may include, but do not have to include, various optical features to enhance the distribution of light emitted from the LEDs 32. For example, lenses 50 can be positioned over the LEDs 32 for directing light towards a banner and/or the products. An individual lens 50 may be provided for each LED 32 or alternatively a single lens 50 may be provided for an array of LEDs 32, as shown in FIG. 2. The lenses 50 can be refractive with symmetrical, asymmetrical, or non-symmetrical light output, include a diffractive optical element, or otherwise be tailored to produce the desired light output. The lenses 50 could be made out of glass, acrylic, polycarbonate, or any other optically clear material. The lenses 50 may be contoured as desired and need not be curved and/or straight as shown in the figures.

The lenses 50 may be mounted to the printed circuit boards 44 or alternatively to the frame 34 using any chemical or mechanical retention method, including the use of mechanical fasteners or adhesive. In one embodiment, screws (not shown) are used to secure the lenses 50 to the frame 34. In an alternative embodiment, wings 52 provided on the lenses 50 are fitted within slots or recesses provided in the frame 34.

In addition to imparting optical properties to the assembly, the lenses 50 also serve to protect the LEDs 32 against moisture within the refrigerated display unit 10. A gasket material or seal (not shown) may be provided around the base of the lenses 50 to ensure that the LEDs 32 are sealed within the lenses 50 and thereby protected from the elements. The lenses 50 also prevent individuals from contacting the LEDs 32 and thus prevent electric shock associated with such contact.

A reflector 54 (see FIG. 4) may be positioned around some or all of the LEDs 32 to reflect light in a symmetrical, asymmetrical, or non-symmetrical manner. The reflector 54 may be made out of vacuum metalized or painted thermoplastic or thermoset materials, formed aluminum or steel, or any other reflective material.

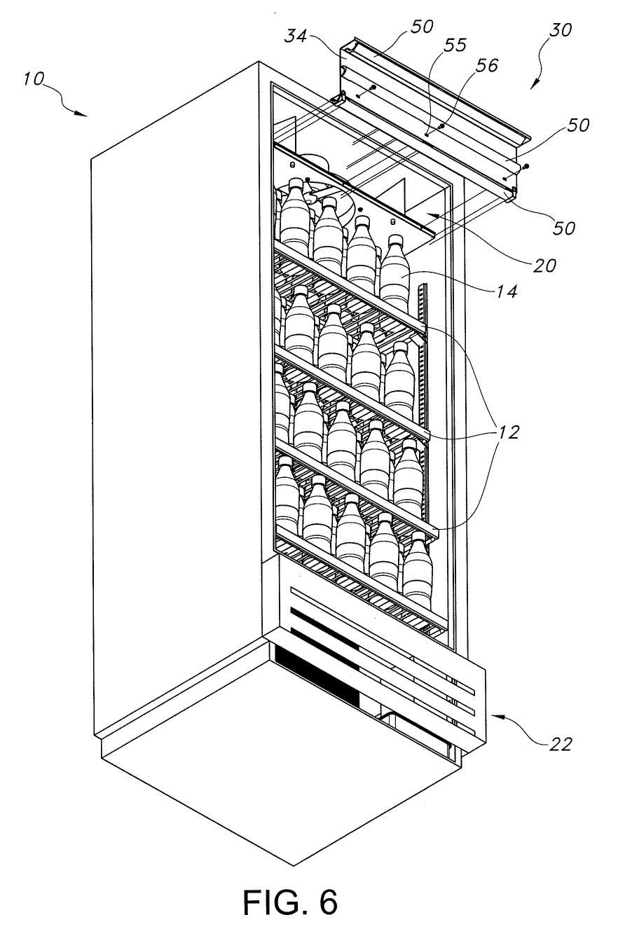

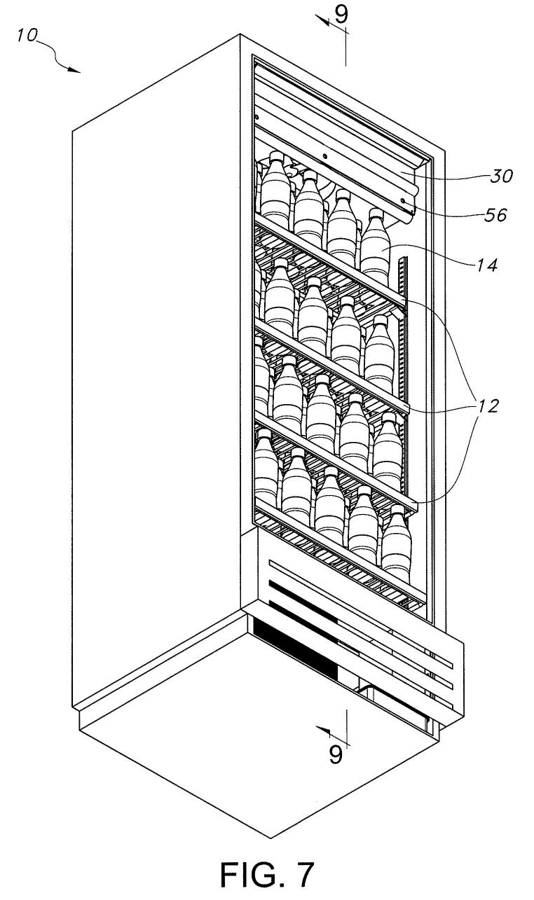

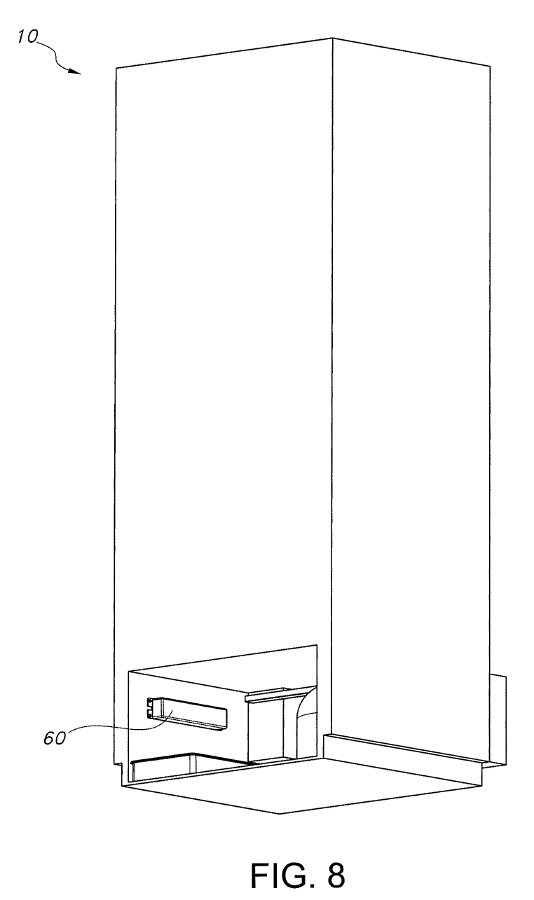

The lighting assemblies 30 disclosed herein may be retrofit into existing refrigerated display units 10 illuminated by fluorescent bulbs 16 or installed in new units 10 during assembly. Retrofitting a lighting assembly 30 into an existing refrigerated display unit 10 can be quickly and easily accomplished in the field. The existing fluorescent lamp 16 and mounting panel 18 are removed from the refrigerated display unit 10 and the lighting assembly 30 installed to fill the vacancy within the unit 10, as shown in FIGS. 6 and 7. The lighting assembly 30 can be retained within the refrigerated display unit 10 via any means, including, but not limited to, interference fit, mechanical fasteners (such as screws 56 engaged in screw holes 55), etc. The fluorescent ballast, typically housed in a lower compartment 22 of the refrigerated display unit 10, can be removed and replaced with an LED driver 60, shown in FIG. 8. While new wiring may be provided during installation, the lighting assembly 30 and LED driver 60 can be wired into the existing wiring of the refrigeration display unit 10. The ends of the wires that formerly connected to the fluorescent bulb 16 can be stripped and spliced with those of the lighting assembly 30. Similarly, the end of the wires that formerly connected to the fluorescent ballast can be stripped and connected to the LED driver 60.

While particularly useful in retrofit applications, the lighting assemblies 30 may also be installed directly into new refrigerated display units 10. Regardless of whether the lighting assemblies 30 are installed in existing or new display units 10, they are easily removable from and replaceable in such units 10 by merely disconnecting the wires, removing the used, existing lighting assembly 30, inserting the new, replacement lighting assembly 30, and reconnecting the wires.

The lighting assemblies 30 disclosed herein may be tailored to provide LEDs 32 and optional optical enhancements to better harness and direct the light emitted from the light sources in the desired directions. In this way, the products housed within the refrigerated display unit 10 and/or the banner on the refrigerated display unit 10 may be better illuminated.

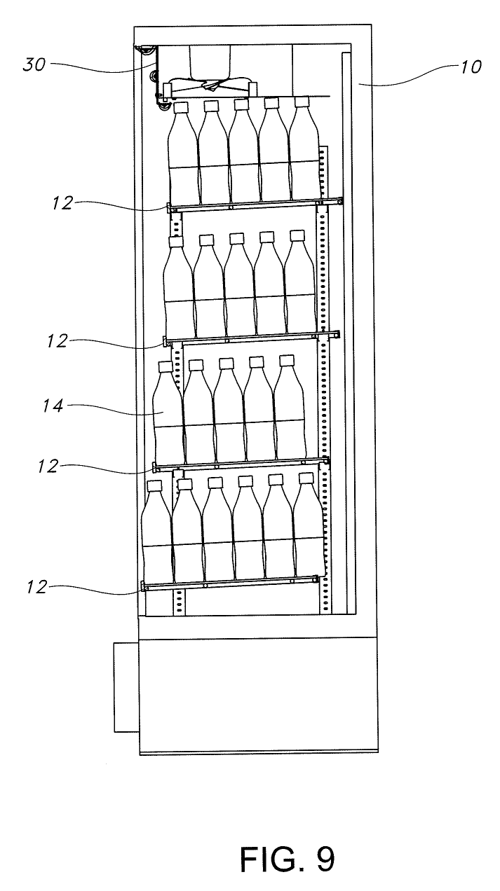

While not required, provision of staggered shelving within the refrigerated display unit 10 is preferable. In its simplest arrangement, the shelves 12 are staggered such that the depth of the shelves 12 gradually increases from top to bottom. FIG. 9 illustrates one embodiment of how the staggered shelving can be configured. Such an arrangement allows the light emanating from the top of the refrigerated display unit 10 to better reach and illuminate the products located on the lower shelves 12.

The lighting assemblies 30 of this invention may be used alone or in conjunction with other lighting assemblies within a refrigerated lighting unit 10. For example, additional LEDs may be provided vertically down or horizontally back or across the back or side walls of the refrigerated display unit or the product shelves 12 within the unit. Moreover, LEDs can be mounted on or embedded within the glass door or mounted between two panes of glass forming the door of the refrigerated display unit 10.

The lighting assemblies 30 need not use only white LEDs. Rather color or multicolor LEDs may be provided. Nor must all of the LEDs within a lighting assembly or within an LED array be the same color. With colored discrete or multicolor die LEDs, it is possible to select a variety of colors with which to illuminate the inside of a refrigerated display unit 10 or to program specific colors for each section of the unit 10. For example, an LED 32 provided in the lighting assembly 30 could emit light of the same color as the products positioned directly below the LED, resulting in improved product color rendering.

The light output of the LEDs 32 need not be consistent. Rather, the LEDs 32 may be programmed to change in appearance. For example, the LEDs 32 may flash, increase and decrease in brightness, switch on and off to create a bubbling effect simulating soda, pulsate, and/or create a moving effect, such as by racing across the unit or creating the appearance of a wave. It is contemplated that such lighting effects could be triggered upon detection (such as by a motion sensor provided in, on, or near the refrigerated display unit 10) of a person approaching the unit.

To conserve energy and associated costs, the refrigerated lighting unit 10 need not be illuminated at all times or be illuminated the same at all times. Moreover, not all of the LEDs 32 need be illuminated at the same time, but rather one can selectively illuminate some or all of the LEDs 32 as desired. For example, the LEDs 32 could be programmed to turn off at night. The LEDs 32 could be switched off when the door opens by use of a mechanical, optical, electrical, proximity, or magnetic switch. When the door opens, the LEDs 32 focusing on banner illumination can be turned off to prevent light from impinging on the individual opening the door.

Ultraviolet LEDs may be used to reduce energy costs during non-peak times. During these times, the ultraviolet LEDs would illuminate fluorescent materials on the products or refrigerated unit labels. Such ultraviolet LEDs may be used to create a glowing affect that would make graphics strikingly visible in the dark.

A light enhancement film, such as 3M Uniform Light Panel, may be provided on the glass behind the banner to distribute the light more evenly on the banner.

Another embodiment according to the present invention places O-LEDs on an outside surface of the refrigerated lighting unit in any size, shape or logo desired, covering all, or a portion, of the surface. These O-LEDs could be designed to flash, pulse, gradually increase and decrease in brightness or otherwise change their light output in a pre-programmed pattern or in response to external stimuli.

The foregoing is provided for purposes of illustrating, explaining, and describing embodiments of the present invention. Further modifications and adaptations to these embodiments will be apparent to those skilled in the art and may be made without departing from the scope or spirit of the invention.

We claim:

1. A method of retrofitting with light emitting diodes a display unit comprising at least one fluorescent bulb mounted on a mounting panel, a fluorescent driver, and at least one connecting wire connecting the fluorescent bulb and the fluorescent driver, the method comprising:
a. removing the fluorescent bulb and mounting panel and the fluorescent driver from the display unit;
b. positioning a lighting assembly in the display unit, wherein the lighting assembly comprises:
(i) a frame; and
(ii) a plurality of light emitting diodes mounted on the frame;
c. positioning a light emitting diode driver in the display unit; and
d. electrically connecting the light emitting diode driver to the lighting assembly.

2. The method of claim 1, wherein electrically connecting the light emitting diode driver to the lighting assembly comprises attaching a first end of the at least one connecting wire to the lighting assembly and attaching a second end of the at least one connecting wire to the light emitting diode driver.

3. The method of claim 1, wherein the frame comprises at least a first and a second mounting arm, wherein at least one light emitting diode is mounted on each of the first and second mounting arms.

4. The method of claim 3, wherein the light emitting diodes mounted on the first and second mounting arms emit light and wherein at least some of the light emitted from the at least one light emitting diode mounted on the first mounting arm is directed in a first direction and at least some of the light emitted from the at least one light emitting diode mounted on the second mounting arm is directed in a second direction different from the first direction.

5. The method of claim 3, wherein the frame further comprises a third mounting arm and at least one light emitting diode mounted on the third mounting arm.

6. The method of claim 1, wherein at least some of the light emitting diodes comprise white or color or multi-color light emitting diodes.

7. The method of claim 1, wherein the lighting assembly further comprises at least one lens positioned adjacent at least some of the light emitting diodes.

8. The method of claim 7, wherein the at least one lens is positioned adjacent a plurality of the at least some light emitting diodes.

9. The method of claim 1, wherein the display unit comprises a top and a bottom and a plurality of shelves each having a depth, wherein the depth of the shelves increases from the top to the bottom of the display unit.

10. A lighting assembly for a display unit comprising:
a. a frame comprising at least a first mounting arm and a second mounting arm oriented at an angle relative to the first mounting arm;
b. at least one light emitting diode mounted on each of the first and second mounting arms, wherein the light emitting diodes mounted on the first and second mounting arms emit light and wherein at least some of the light emitted from the at least one light emitting diode mounted on the first mounting arm is directed in a first direction and at least some of the light emitted from the at least one light emitting diode mounted on the second mounting arm is directed in a second direction different from the first direction; and
c. at least one lens positioned adjacent at least one light emitting diode, wherein the lighting assembly is insertable into and removable from the display unit.

11. The lighting assembly of claim 10, wherein the frame comprises metal.

12. The lighting assembly of claim 10, wherein a surface of the frame is reflective.

13. The lighting assembly of claim 10, wherein the first and second mounting arms are oriented at a non-perpendicular angle relative to each other.

14. The lighting assembly of claim 10, wherein the frame further comprises a third mounting arm and at least one light emitting diode mounted on the third mounting arm.

15. The lighting assembly of claim 10, wherein at least some of the light emitting diodes comprise white or color or multi-color light emitting diodes.

16. The lighting assembly of claim 10, wherein at least some of the light emitting diodes are mounted on printed circuit board.

17. The lighting assembly of claim 10, wherein the lighting assembly further comprises a plurality of lenses, each positioned adjacent at least one light emitting diode.

18. The lighting assembly of claim 17, wherein a lens is positioned adjacent a plurality of light emitting diodes.

19. The lighting assembly of claim 10, wherein the lighting assembly further comprises a reflector positioned at least partially around at least one light emitting diode.

20. A display unit having a top and a bottom and comprising:
a. a lighting assembly positioned proximate the top of the unit, wherein the lighting assembly comprises:
(i) a frame comprising at least a first mounting arm and a second mounting arm oriented at an angle relative to the first mounting arm;
(ii) at least one light emitting diode mounted on each of the first and second mounting arms, wherein the light emitting diodes mounted on the first and second mounting arms emit light and wherein at least some of the light emitted from the at least one light emitting diode mounted on the first mounting arm is directed in a first direction and at least some of the light emitted from the at least one light emitting diode mounted on the second mounting arm is directed in a second direction different from the first direction; and
(iii) at least one lens positioned adjacent at least one light emitting diode;
b. a light emitting diode driver positioned proximate the bottom of the unit; and
c. a plurality of shelves each having a depth, wherein the depth of the shelves increases from the top to the bottom of the display unit.
